(19) United States
(12) Patent Application Publication
(10) Pub. No.: US 2004/0182895 A1
(43) Pub. Date: Sep. 23, 2004

(54) Child sling

(76) Inventor: Laurie Paul, Woods Cross, UT (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/793,316

(22) Filed: Mar. 4, 2004

Related U.S. Application Data
(60) Provisional application No. 60/455,156, filed on Mar. 17, 2003.

(51) Int. Cl. A61G 1/00

(52) U.S. Cl. 224/159

(57) ABSTRACT

A child sling is disclosed that may be used to hold and carry a child. The child sling includes a harness that is sized to encircle an adult person and a child. The harness is designed such that it holds the child proximate to the person's waist. The harness is usually made of a cloth or fabric material. The child sling also has a first strap and a second strap that are attached to the harness. A latch is also added to connect the first strap and the second strap. The child sling may also be designed such that when the sling encircles the person and a child, no portion of the child sling contacts the person's shoulders. Additionally, the child sling may also be designed such that when the sling encircles a person and a child, the sling holds the child proximate the person's waist without the use of shoulder straps.

### CROSS-REFERENCED RELATED APPLICATIONS

This application claims the benefit of U.S. Provisional Application No. 60/455,156, filed on Mar. 17, 2003, by Laurie Paul, which provisional application is incorporated herein by reference.

### BACKGROUND OF THE INVENTION

The present invention relates to sling or carrier that is capable of holding and carrying a child. More specifically, the present invention relates to a sling that is capable of holding and carrying a child proximate to the adult person's waist.

Child slings or carriers are accepted in the art as a means by which an adult may carry or hold the child without compromising the free and independent movement of the adult's shoulders and arms. For background information on many child slings or carriers, the reader is invited to examine U.S. Pat. No. 4,149,687 and U.S. Pat. No. 5,678,739, which patents are incorporated herein by reference.

As noted by U.S. Pat. No. 5,678,739, the purpose of most known child carriers is to provide the adult with a mechanism for carrying the infant or child while the adult is actively moving, performing chores, running errands, shopping, and the like. Regrettably however, such carriers designed for active movement have proven uncomfortable or unsuitable for sedentary situations such as during a movie or other performance, during ceremonies, during church, and the like.

Furthermore, most of the known child carriers include a shoulder strap or other similar portion that is designed to engage/contact the adult's shoulders. These shoulder straps are designed so that at least a portion of the carrier may be worn over the adult's shoulders. However, for some adults, these shoulders straps are restrictive, bothersome, and/or awkward to use. Thus, for such individuals that disfavor the use of shoulder straps, the currently available child carriers are simply unsatisfactory.

Moreover, many known child carriers require multiple straps and connecting buckles to adequately hold the child within the carrier. Manufacturers believe that these multiple straps and connecting buckles are necessary to support and restrain the movement of the child within the carrier. Unfortunately, the downside of these multiple straps and connecting buckles is that the overall complexity of the carrier is significantly increased. Similarly, these multiple straps and connecting buckles also increase the time required to secure the child within the carrier. Again, for many “on-the-go” adults, this increase in time required to secure the child within the carrier is unacceptable.

Finally, many currently designed child carriers are somewhat unfashionable and lacking in style. As a result, many people, including people who have infants or small children, have difficulty finding the desire to wear or use their child carrier in public.

Accordingly, there is a need in the art for a novel child carrier that addresses and/or solves one or more of the above-listed problems. Such a device and method is disclosed herein.

### BRIEF SUMMARY OF THE INVENTION

The apparatus of the present invention has been developed in response to the present state of the art, and in particular, in response to the problems and needs in the art that have not yet been fully solved by currently available child carriers. Thus, the present invention comprises a child sling that is constructed such that it is capable of holding or carrying a child proximate to an adult person's waist.

The child sling generally comprises a harness that is made of a cloth, fabric, leather, plastic, or other materials (including mixtures or combinations or the foregoing) that are strong enough to hold and/or support the weight of a child. The harness is sized to have a length sufficient to allow the harness to encircle a person and a child when the child is positioned proximate the person's waist. The width of the harness is set such that the harness is capable of supporting the weight of a child.

The child sling also includes a first strap and a second strap. The first strap and the second strap are attached to the harness. The first strap may be positioned proximate one end of the harness whereas the second strap is positioned such that it is proximate the opposite end. The harness may be further designed such that the first strap and/or the second strap are threaded through one or more binding loops.

A latch that is constructed to connect the first strap to the second strap to is also added to the sling. The latch is designed such that if a child is positioned proximate the person's waist, the latch connects the first strap and the second strap and secures and/or causes the sling to hold the child proximate the person's waist.

The child sling may be further be designed to hold the child proximate to the person's waist without the use of shoulder straps (or any other portion or feature that is designed to contact and/or engage the person's shoulders). Rather, the child sling is configured such that when the sling holds the child, no portion of the child sling engages or contacts the person's shoulders.

These and other features and advantages of the present invention will become more fully apparent from the following description and appended claims, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of the child sling of the present invention;

FIG. 2 is a perspective view of one embodiment of the latch that may be used as part of the present invention;

FIG. 3 is a perspective view illustrating how the child sling of the present invention holds a child while the adult person is in the seated position; and

FIG. 4 is a perspective view illustrating how the child sling of the present invention holds a child while the adult person is in the standing position.

### DETAILED DESCRIPTION OF THE INVENTION

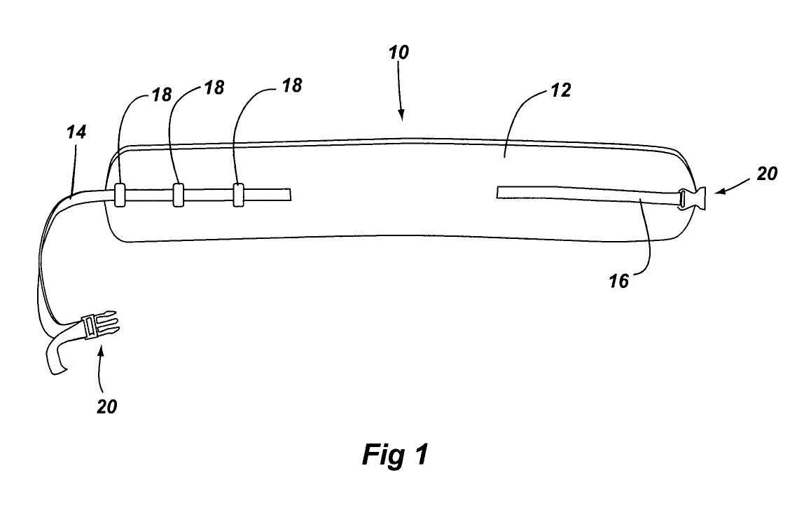

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the child sling of the present invention, as represented in FIGS. 1 through 4, is not intended to limit the scope of the invention, as claimed, but is merely representative of presently preferred embodiments of the invention.

Referring now to FIG. 1, a child sling 10 according to the present invention is illustrated. The child sling 10 is constructed such that it is capable of holding or carrying a child proximate the person's waist. The child sling 10 generally comprises a harness 12. The harness 12 is sized to have a length sufficient to allow the harness 12 to encircle a person and a child that is positioned proximate the person's waist. This length may be between about 4 feet to about 6 feet. In other embodiments, the length of the harness 12 may be about five (5) feet. The width of the harness 12 is set such that the harness 12 is capable of supporting the weight of a child. In some embodiments, this width may be about between about 4 inches to about 12 inches. In other embodiments, this width may be about 7 inches.

The harness 12 is made of a cloth or fabric material that is strong enough to hold and/or support the weight of a child. This may be accomplished by lining the harness 12 with a fleece material. However, other embodiments may be made using other types of cloth or fabric. Still further embodiments may be made in which the harness 12 comprises leather, plastic, or another material other than a cloth or a fabric. Combinations and/or mixtures of any of different types of materials may also be used.

The child sling 10 may further comprise a first strap 14 and a second strap 16. The first strap 14 and the second strap 16 are attached to the harness 12. The first strap 14 may be positioned proximate one end of the harness 12 whereas the second strap 16 is positioned such that it is proximate the opposite end. In other embodiments, the first strap 14 and the second strap 16 may be attached together and/or be portions or sections of one continuous strap.

In the embodiment shown in FIG. 1, the first strap 14 and the second strap 16 are attached to the harness 12 via sewing. However, to strengthen the connection between the first strap 14 and the harness 12, one or more binding loops 18 may also be added. The binding loops 18 are designed such that the first strap 14 may be threaded through the binding loops 18.

Of course, other embodiments may be made in which the first strap 14 and/or the second strap 16 are attached to the harness 12 via other methods such as through hemming, stitching, RF welding, and like. Other embodiments may also comprise one or more additional binding loops 18. More specifically, other embodiments may be made in which the one or more loops 18 bind the second strap 16 and/or the first strap 14.

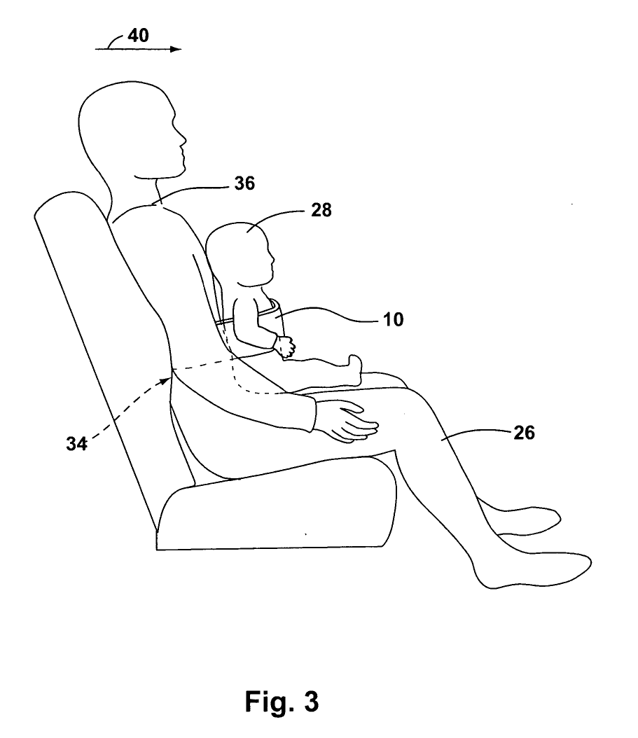

The child sling 10 may further comprise a latch 20. The latch 20 is constructed to connect the first strap 14 to the second strap 16. Specifically, if a child is positioned proximate the waist of a person (shown in FIG. 3), the latch 20 connects the first strap 14 and the second strap 16 and causes the sling 10 to hold the child proximate the person's waist.

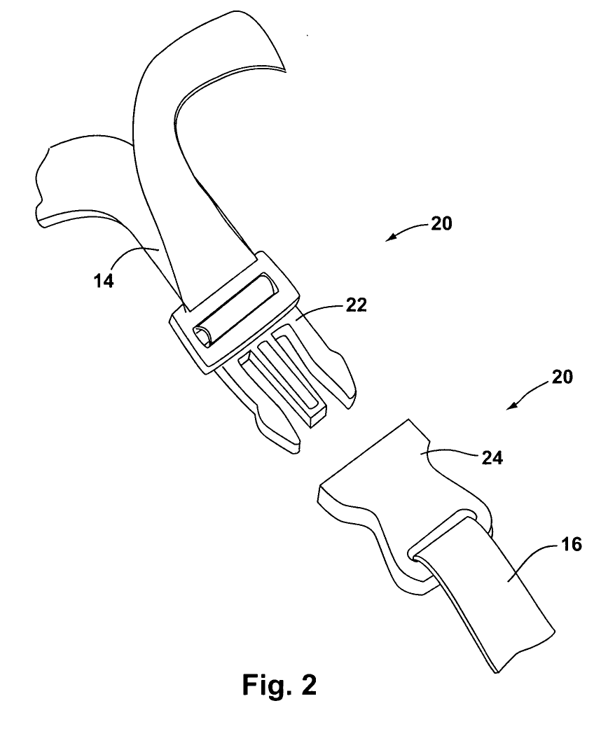

Referring now to FIG. 2, one embodiment of the latch 20 is shown in greater detail. In FIG. 2, the latch 20 comprises two members, an inserting member 22 and a receiving member 24. The inserting member 22 is attached to the first strap 14 and the receiving member 24 is attached to the second strap 16. The inserting member 22 and the receiving member 24 may be interlocked together by having a portion of the inserting member 22 be inserted into the receiving member 24.

However, other embodiments of the present invention may be made in which the latch 20 differs from that which is shown in FIG. 2. Specifically, some embodiments may be made in which the latch 20 comprises a buckle. Yet further embodiments may be made in which the latch 20 comprises a loop. In fact, any mechanism or device that is capable of attaching the first strap 14 to the second strap 16 may be used as the latch 20. Yet further embodiments may also be constructed in which the latch 20 comprises a knot such that the first strap 14 is joined to the second strap 16 via tying.

In the embodiment shown in FIG. 2, the first strap 14 has been threaded through a portion of the inserting portion 22. Accordingly, the position of the inserting portion 22 may be varied along the length of the first strap 14. Such varying of the position of the inserting portion 22 allows the size of the child sling 10 to be adjusted to fit and/or acconmmodate each specific user. Of course, other embodiments may also be made in which the second strap 16 is threaded through a portion of the receiving portion 24. In these embodiments, the size of the child sling 10 may be adjusted by varying the position of the inserting portion 22 along the length of the first strap 14 and/or varying the position of the receiving portion 24 along the length of the second strap 16.

Referring now to FIG. 3, the way in which the child sling 10 of the present invention may be used to hold a child 28 is depicted. In FIG. 3, an adult person 26 is shown in a seated position. The child 28 is has been positioned in front of the person 26 proximate the person's waist 34. The child sling 10 encircles the child 28 and the person 26 proximate the person's waist 34. The child 28 is then secured proximate the person's waist 34. Such securing of the child 28 may be accomplished by using the latch 20 (not shown) to connect the first strap 14 (not shown) to the second strap 16 (not shown). Such connection of the first strap 14 and the second strap 16 causes the sling 10 to hold the child 28 proximate the person's waist 34.

The child sling 10 may further be designed such that the child sling 10 holds the child 28 proximate to the person's waist 34 without the use of shoulder straps or other portions designed to contact or engage the person's shoulders 36. Rather, as shown in FIG. 3, the child sling 10 is designed such that when the sling 10 holds the child 28, no portion of the child sling 10 engages or contacts the person's shoulders 36.

The child sling 10 may also be designed such that when the child 28 is held proximate to the person's waist 34, both the child 28 and the person 26 are facing in a forward direction (as indicated by the arrow 40). Of course, other embodiments may also be designed in which the child sling 10 is designed such that when the child 28 is held proximate to the person's waist 34, the child 28 and the person 26 are facing in opposite and/or different directions.

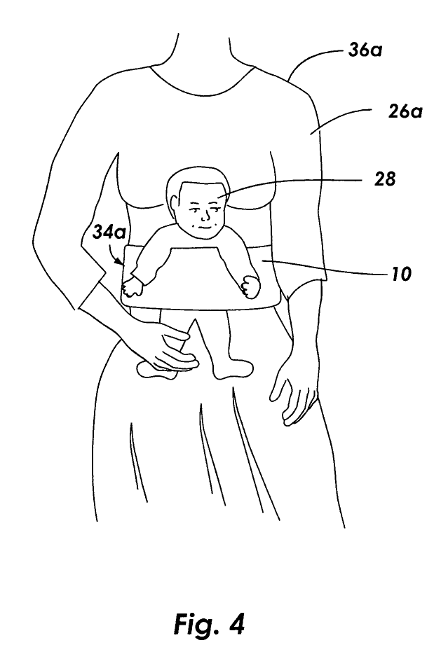

FIG. 4 illustrates the way in which the child sling 10 holds a child 28 while a person 26a is in the standing position. As shown in FIG. 4, when the person 26a, the child sling 10 is designed to hold the child 28 proximate to the person's waist 34a without the use of shoulder straps or other portions designed to contact or engage the person's shoulders 36. Rather, the child sling 10 is designed such that when the sling 10 holds the child 28, no portion of the child sling 10 engages or contacts the person's shoulders 36a.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A child sling for holding or carrying a child, the sling comprising:
a harness sized to encircle a person and a child, the harness being constructed to hold the child proximate a person's waist,
a first strap and a second strap, the first and second strap being attached to the harness; and
a latch for connecting the first strap and the second strap, wherein the child sling is designed such that when the sling encircles a person and a child, no portion of the child sling contacts the person's shoulders.

2. A child sling as in claim 1 wherein the width of the harness is between about 4 inches and about 12 inches.

3. A child sling as in claim 1 wherein the length of the harness is between about 4 feet and about 6 feet.

4. A child sling as in claim 1 wherein the harness is lined with a fleece material.

5. A child sling as in claim 1 wherein the latch is added to the end of the first strap.

6. A child sling as in claim 1 wherein the size of the child sling is adjustable.

7. A child sling as in claim 6 wherein the size of the child sling is adjustable by changing the position of the latch.

8. A child sling as in claim 1 wherein the first strap is disposed proximate one end of the harness and the second strap is disposed proximate the opposite end of the harness.

9. A child sling as in claim 1 wherein the first strap and the second strap are attached to the harness via sewing.

10. A child sling as in claim 1 further comprising one or more binding loops.

11. A child sling as in claim 10 wherein the first strap is threaded through the one or more binding loops.

12. A child sling as in claim 1 wherein the child sling is designed such that when the sling encircles a person and a child, both the child and the person are facing in the same direction.

13. A child sling as in claim 1 wherein the latch comprises an inserting portion attached to the first strap and a receiving portion attached to the second strap.

14. A child sling for holding or carrying a child, the sling comprising:
a harness sized to encircle a person and a child, the harness being constructed to hold the child proximate a person's waist,
a first strap and a second strap, the first and second strap being attached to the harness; and
a latch for connecting the first strap and the second strap, wherein the child sling is designed such that when the sling encircles a person and a child, no portion of the child sling contacts the person's shoulders, wherein the sling is further constructed to hold the child proximate a person's waist without the use of shoulder straps.

15. A child sling as in claim 14 wherein the harness is about 7 inches wide and about five feet in length.

16. A child sling as in claim 14 wherein the harness is lined with a fleece material.

17. A child sling as in claim 14 wherein the latch comprises an inserting portion attached to the first strap and a receiving portion attached to the second strap.

18. A child sling as in claim 14 wherein the size of the child sling is adjustable.

19. A child sling as in claim 14 wherein the first strap is disposed proximate one end of the harness and the second strap is disposed proximate the opposite end of the harness.

20. A child sling as in claim 14 further comprising one or more binding loops.

21. A child sling as in claim 20 wherein the first strap is threaded through the one or more binding loops.

22. A child sling for holding or carrying a child, the sling comprising:
a harness sized to encircle a person and a child, the harness being constructed to hold the child proximate a person's waist,
a first strap and a second strap, the first and second strap being attached to the harness; and
a latch for connecting the first strap and the second strap, wherein the child sling is designed such that when the sling encircles a person and a child, the sling holds the child proximate a person's waist without the use of shoulder straps.

23. A child sling as in claim 22 wherein the first strap is disposed proximate one end of the harness and the second strap is disposed proximate the opposite end of the harness.

24. A child sling as in claim 22 wherein the latch comprises an inserting portion attached to the first strap and a receiving portion attached to the second strap.

25. A child sling as in claim 22 wherein the size of the child sling is adjustable.

26. A child sling as in claim 22 further comprising one or more binding loops.

27. A child sling as in claim 26 wherein the first strap is threaded through the one or more binding loops.

28. A method for holding or carrying a child proximate to a person's waist using a sling that comprises a harness, a first strap and a second strap that are attached to the harness, and a latch for connecting the first strap and the second strap, the method comprising:
placing the child proximate the child's waist;
encircling the person and the child with the child sling; and
securing the child proximate to the person's waist so that the child sling holds the child proximate a person's waist without the use of shoulder straps.

29. A method for holding or carrying a child as in claim 28 wherein the securing step is accomplished by using the latch to connect the first strap and the second strap.

30.

31. A method for holding or carrying a child as in claim 28 wherein the child sling is designed such that when the sling encircles a person and a child, no portion of the child sling contacts the person's shoulders.

32. A method for holding or carrying a child proximate to a person's waist using a sling that comprises a harness, a first strap and a second strap that are attached to the harness, and a latch for connecting the first strap and the second strap, the method comprising:
placing the child proximate the child's waist;
encircling the person and the child with the child sling; and
securing the child proximate to the person's waist such that no portion of the child sling contacts the person's shoulders.

33. A method for holding or carrying a child as in claim 28 wherein the securing step is accomplished by using the latch to connect the first strap and the second strap.

34. A method for holding or carrying a child as in claim 28 wherein the child sling is designed such that when the sling encircles a person and a child, the sling holds the child proximate a person's waist without the use of shoulder straps.
